(19) United States
(12) Patent Application Publication
(10) Pub. No.: US 2002/0062912 A1
(43) Pub. Date: May 30, 2002

(54) Mat product communication system

(75) Inventors: Smarajit Mitra, West St. Paul, MN (US); Alexander C. Tsuei, Woodbury, MN (US); James W. Sinclair, Eagan, MN (US)

Correspondence Address: Michaele A. Hakamaki, Office of Intellectual Property Counsel, 3M Innovative Properties Company, P.O. Box 33427, St. Paul, MN, 55133-3427, US

(73) Assignee: 3M Innovative Properties Company

(21) Appl. No.: 09/727,231

(22) Filed: Nov. 30, 2000

(51) Int. Cl. B31C 1/00

(52) U.S. Cl. 156/189; 156/249

(57) ABSTRACT

A method of communicating information is provided, wherein the method includes providing a base mat adapted for receiving at least one replaceable sheet, where the base mat has first and second opposing surfaces. The method further includes providing a first replaceable sheet having a base surface and an opposing face surface, wherein the face surface displays indicia. The first replaceable sheet is removably attached to at least a portion of the first surface of the base mat so that the base surface of the sheet faces the first surface of the base mat, where it is displayed for a period of time. When it is desired to change the indicia, the first replaceable sheet is removed, and a second replaceable sheet is provided having a base surface and an opposing face surface, wherein the face surface displays indicia. The second replaceable sheet is removably attached to at least a portion of the first surface of the base mat so that the base surface of the sheet faces the first surface of the base mat.

### TECHNICAL FIELD

The present invention relates to mats and matting products. More particularly, the present invention provides a system of communicating information with a changeable mat product.

### BACKGROUND OF THE INVENTION

Floor matting is commonly used inside and outside homes and businesses to address various cleanliness and safety concerns. For example, many types of floor matting are available for placement at the entrances of buildings for removing dirt and moisture from the shoe soles of people entering the building. The matting thereby helps to keep the floor in the entryway and throughout the rest of the building clean and dry.

Because floor matting is so widely used in heavily traveled areas, it is also desirable that the matting be aesthetically pleasing to the observer. Matting can be selected in various colors and shapes to compliment the area in which the matting will be placed. It also may be desirable to provide images or decorations on the matting material. Simple images, such as single color emblems, logos, and the like, have been used on matting and are typically applied by printing or spraying the image onto the top surface of the matting. While these images may be satisfactory immediately after printing, the structural durability of the mat is usually greater than the durability of the image on the mat surface. Thus, the image typically deteriorates more quickly than the mat itself wears out.

Another way to provide a mat with an image or decoration involves combining matting materials of different colors into a single matting product. To do this, the perimeter of a particular pattern or image, such as a logo or emblem, is cut from a first matting material to leave a hole or void in the material. A complementary pattern or image is cut from a second matting material, which is typically a different color than the first matting material. The cut-out portion from the second material is then inserted into the hole in the first material and the portions are bonded together so that the mat can be moved as a single matting unit. While the images provided by this matting construction are often durable, they are also limited to relatively simple images that can readily be made by this method.

The matting types discussed above can provide satisfactory images for various applications, however, some users desire matting with more complicated images, such as those having multiple colors and intricate shapes. It is further desirable that the images or graphics can be removable and replaceable, such as for advertising purposes where a particular graphic is useful for only a temporary period before a particular sale or promotion has expired and is replaced by a new promotion that is represented by a different graphic. For example, a fast-food restaurant may have a different food item on sale each month, where it would be desirable to change the graphics on the mat to correspond with the particular food item on sale.

### SUMMARY OF THE INVENTION

In one aspect of this invention a method of communicating information is provided, wherein the method includes providing a base mat adapted for receiving at least one replaceable sheet, where the base mat has first and second opposing surfaces. The method further includes providing a first replaceable sheet having a base surface and an opposing face surface, wherein the face surface displays indicia. The first replaceable sheet is removably attached to at least a portion of the first surface of the base mat so that the base surface of the sheet faces the first surface of the base mat, where it is displayed for a period of time. When it is desired to change the indicia, the first replaceable sheet is removed, and a second replaceable sheet is provided having a base surface and an opposing face surface, wherein the face surface displays indicia. The second replaceable sheet is removably attached to at least a portion of the first surface of the base mat so that the base surface of the sheet faces the first surface of the base mat.

The method may further comprise a non-slip surface on the face surface of the first replaceable sheet. The replaceable sheets may be affixed to the matting article through the use of adhesives or other fastening means such as hook and loop fasteners or magnetic fasteners.

### BRIEF DESCRIPTION OF THE DRAWINGS

The present invention will be further explained with reference to the appended Figures, wherein like structure is referred to by like numerals throughout the several views, and wherein:

FIG. 1 is a top plan view of a prior art extruded matting product;

FIG. 2a is a perspective view of a matting article with a removable graphic sheet according to the present invention;

FIG. 2b is a perspective view of another matting article with a removable graphic sheet according to the present invention;

FIG. 3 is a cross-sectional view of the matting article taken along line 3-3 of FIG. 2a;

FIG. 4 is a cross-sectional view of an alternative mat with a removable graphic sheet; and

FIG. 5 is a cross-sectional view of a sheet according to the present invention.

### DETAILED DESCRIPTION OF THE PREFERRED EMBODIMENTS

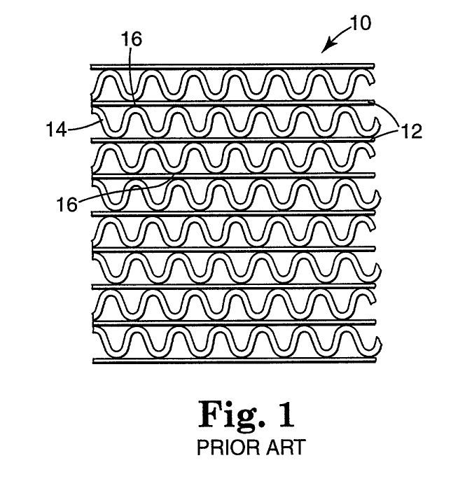

In accordance with the present invention, a method of communicating information using a changeable matting product or assembly has been developed. The matting assembly includes a replaceable graphic sheet that can be affixed to and removed from a base mat. One particular matting product to which the sheet can be applied in accordance with the present invention is commercially available from the Minnesota Mining and Manufacturing Company of St. Paul, Minn., under the trade designation “Entrap” and described in U.S. Pat. No. 4,631,215 (Welygan et al.). This matting 10 is illustrated in FIG. 1 and generally comprises a plurality of straight spaced parallel extruded elements 12 separated by a regularly undulated extruded element 14, with undulations having opposed apexes 16 on either side thereof. The apexes 16 on one side of the undulated element 14 are bonded to one of the parallel extruded elements 12 and the apexes 16 on the other side of the undulated element 14 are bonded to the other of the parallel extruded elements 12.

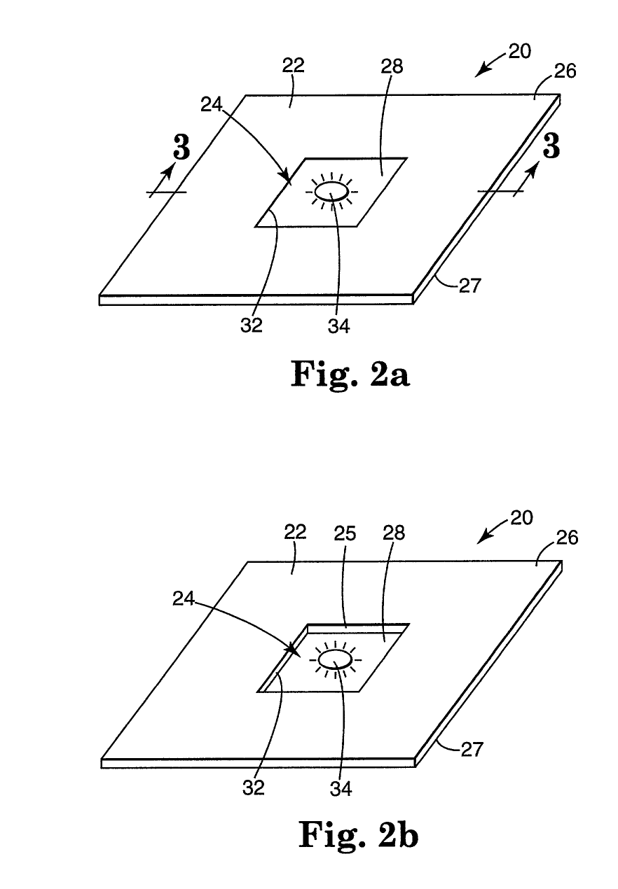

FIGS. 2a and illustrate one preferred embodiment of the present invention, where a matting assembly 20 comprises a base mat 22 (such as the matting type of FIG. 1, for example) with a replaceable sheet 24 affixed thereto. In this embodiment, a portion of base mat 22 is embossed to provide a recessed area 25 of the mat. The base mat 22 may be embossed by a process such as pressing a hot stamp in a desired shape onto a top surface 26 of the base mat 22 until the area is recessed a particular amount as compared to top surface 26 of the base mat 22, thereby creating the recessed area 25. In the illustrated embodiment, recessed area 25 is defined by a bottom wall 30 and four side walls 32. However, it is understood that more or less than four walls may define the periphery of the recessed area 25 and that any desirable shape may be used for the area. The depth D of the recessed area 25 is equal to the distance between top surface 26 of mat 22 and bottom wall 30.

Other methods may also be used to provide a matting assembly 20 with a recessed area 25. For example, the base mat 20 may be molded with a recessed area 25 in the desired location, such as by injection molding. The mat 20 may also be extruded with a desired recessed area 25, or may have the recessed area 25 provided in another manner.

Replaceable sheet 24, which is preferably generally the same size and shape as the recessed area 25, is positioned within the recessed area 25 of base mat 22 and may have a graphical image or indicia 34 printed thereon. In FIG. 2a, the thickness of sheet 24 is approximately equal to the depth D of recessed area 25 so that top surface 28 of sheet 24 is generally flush with the top matting surface 26. Another embodiment of the invention is shown in FIG. 2b, where the thickness of sheet 24 is less than the depth D of recessed area 25, so that the top surface 28 of sheet 24 is at least slightly below the top matting surface 26. While the thickness of the sheet 24 is preferably less than or equal to the depth D of recessed area 25 so that sheet 24 does not extend above the top matting surface 26, it is also contemplated that the sheet 24 actually have a greater thickness than the depth D of the recessed area 25 so that sheet 24 extends above the top matting surface 26.

As illustrated in the Figures, side walls 32 are generally perpendicular to top surface 26 and bottom wall 30. Alternatively, the side walls 32 may be angled or otherwise oriented relative to top matting surface 26 and bottom wall 30. In either case, it is preferable that the shape of the sheet 24 closely match the shape of the recessed area 25 so that the sheet 24 generally fills recessed area 25 when inserted therein.

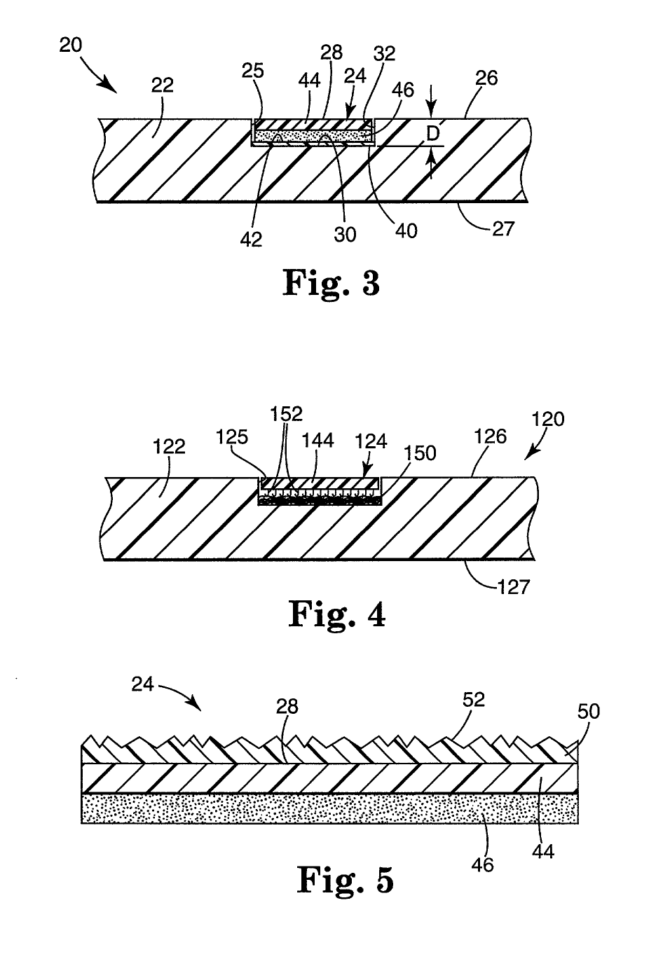

In accordance with the present invention, sheet 24 should be relatively easy to remove from base mat 22 to allow for replacement with another sheet 24, however, sheet 24 also should be sufficiently secured to the mat so that it does not move about or become disengaged from the mat 22 when people repeatedly step on its surface. This may be accomplished through the choice of materials contacting each other in matting assembly 20. In one preferred embodiment shown in FIG. 3, a coating layer 40, which may be a polyester film layer, for example, is coated on or adhered to bottom wall 30 of recessed area 25. Coating layer 40 is preferably generally smooth to provide the greatest amount of surface area for receiving a sheet 24 onto its upper surface 42. The corresponding sheet 24 is shown positioned within recessed area 25 and includes a base layer 44 and an adhesive layer 46. In this embodiment, where coating layer 40 is a polyester film, adhesive layer 46 is preferably a non-tacky adhesive, such as a butadiene-acrylonitrile copolymer having high shear and relatively low peel strength properties. Adhesive layer 46 is also preferably washable to allow for cleaning of the sheet 24 without completely degrading the adhesive properties of adhesive layer 46. In this way, sheet 24 may be washed and reused multiple times on the same or a different mat product.

The particular coating layer 40 on the bottom wall 30 and corresponding adhesive layer 46 in each matting configuration should be selected to achieve a desired peel strength between the adhesive layer 46 and the coating layer 40. For example, when the adhesive layer 46 is a butadiene-acrylonitrile copolymer such as that described in U.S. Pat. No. 5,733,652 (Stowman et al.), the coating layer 40 may be polyester film, polyurethane film, or other suitable films as described above. The coating layer 40 may be treated to enhance adhesion of the adhesive layer 46 to the coating layer 40 as is known in the art. Examples of such treatment methods are chemical treatment (e.g., the treatment of an aziridine-primed polyester film as described in U.S. Pat. No. 5,057,371 (Cantry et al.)), and surface modification methods such as by exposure of the film surface of flame, plasma or corona treatment. An example of a suitable corona treated film is that commercially available from Minnesota Mining and Manufacturing Company of St. Paul, Minn. as No. 1220 Scotchpak film. The peel strength can also be influenced by varying the surface smoothness of the coating layer 40, the adhesive layer 46, or both the coating layer 40 and adhesive layer 46 to provide different amounts of surface contact between the two layers, thereby changing the peel strength between the two layers.

When an adhesive such as a butadiene-acrylonitrile copolymer is used for the adhesive layer 46, it should be relatively non-tacky to the touch. In this way, if a user's hand contacts the exposed adhesive, little to no adhesive will be transferred to the user's hand. This provides at least three advantages. First, the user does not need to wear special protective equipment such as gloves to prevent adhesive from transferring to his or her hands, nor does the user need to spend time cleaning adhesive from his or her hands after handling one of the sheets. Second, the adhesive properties of the sheet can remain relatively constant, even after a sheet is removed and replaced multiple times. A third advantage of using a non-tacky adhesive is that multiple sheets with exposed adhesive layers may be stacked or stored on top of each other when not in use without the sheets becoming permanently bonded to one another.

While one preferred adhesive for the adhesive layer 46 is described above, many other suitable adhesives may be used, such as those known as pressure sensitive adhesives. When a pressure sensitive adhesive is used for adhesive layer 46, coating layer 40 on bottom wall 30 may comprise a vinyl material, which is compatible with several types of pressure sensitive adhesives. Examples of pressure sensitive adhesives that may be used for the adhesive layer 46 include latex crepe, rosin, acrylic polymers and copolymers such as polybutylacrylate and polyacrylate ester, vinyl esters such as polyvinyl n-butyl ether, alkyd adhesives, rubber adhesives such as natural rubber, synthetic rubber, chlorinated rubber, and mixtures thereof. The pressure sensitive adhesive can be a continuous pattern or a pattern coating.

It is understood that an adhesive may be used on the replaceable sheet 24, or may be coated or affixed to the recessed area 25 on either the bottom wall 30, the coating layer 40 when a coating layer is used, or on any other layer that is available to accept an adhesive. Alternatively, the adhesive may be on both the replaceable sheet 24 and in the recessed area 25, depending on the desired attachment strength between the sheet 24 and the base mat 22. Moreover, both the replaceable sheet 24 and the recessed area 25 may comprise at least one additional layer that provides and enhances the desired characteristics of sufficient attachment strength during use, while allowing for relatively easy removal of the replaceable sheet 24 when desired. Alternatively, the material selected for sheet 24 may provide the necessary properties to allow it to be secured to a particular base mat 22 without an additional adhesive layer 46.

Replaceable sheet 24 may include a solid color base layer 44. Alternatively base layer 44 may have graphic images or indicia printed on one or both sides thereof. There may also be a separate graphics layer provided that is coated or affixed to base layer 44. Examples of indicia or graphics include information such as directions to an office or room in a building, communication of upcoming promotions or sales, and advertisements of upcoming events, such as sporting events. The graphics may also display a company logo or provide seasonal decorations that can be changed for each upcoming holiday season. Further, replaceable sheet 24 may include additional layers, as desired, to achieve particular visual qualities for each matting product, such as three-dimensional effects.

FIG. 4 illustrates an alternative embodiment of the present invention, where a matting assembly 120 includes a base mat 122 and a replaceable sheet 124 positioned within a recessed area 125. In this embodiment, sheet 124 is secured to base mat 122 with a mechanical fastener, such as a hook and loop fastener. Fasteners of this type typically comprise a loop fabric on one surface that engages with hooks on a mating surface to attach the two surfaces together. As shown, the loop portion of the mechanical fastener is illustrated as a layer 150 within the recessed area 125, while the hook portion of the mechanical fastener is illustrated as layer 152 protruding from replaceable sheet 124. Alternatively, the hook portion may be within the recessed area 125, while the loop portion protrudes from replaceable sheet 124. It is also possible to use hermaphroditic fasteners as taught in U.S. Pat. No. 5,077,870 (Melbye et al.), which is commonly owned by the assignee of the present invention. As with adhesives, the particular mechanical fastener used in each matting should be selected to have a desired level of attachment between the sheet and matting to allow the sheet 124 to be separated from the base mat 122 relatively easily, while providing sufficient attachment between the sheet 124 and mat 122 so that they do not slide relative to one another.

The loop fabric selected can be any suitable fabric such as a brushed fabric, knitted loop fabric, warp knitted loop fabric, stitched loop fabric, woven loop fabric, and the like. These fabrics may further comprise either individual filaments or filaments grouped together as a yarn. Examples of typical filaments include polyamides such as nylon, polyolefins, polyurethanes, aramids, polyester, cellulosic materials, and the like.

The hooks preferably comprise an elongate stem with a hooking head at the end of the elongate stem. The stem may have a cross-sectional shape such as a circle, oval, polygon (including, for example, a star, cross, rectangle, or parallelogram), multi-lobed shape, and the like. The hooking head may have any suitable three-dimensional shape, such as a hemisphere, a sphere, cube, a mushroom cap, a cylinder, a cone, a pyramid, a disc, or a barb. The hooks can be straight or arcuate and may be arranged in a regular array or be randomly arranged.

Another alternative method of securing a replaceable sheet to a base mat is by magnetic attraction between the sheet and the mat. This may be accomplished, for example, where the replaceable sheet comprises a ferromagnetic material and the base mat comprises a magnetized surface. Alternatively, the base mat may comprise a ferromagnetic material and the replaceable sheet may comprise a magnetized surface. The ferromagnetic material may be coated onto the surface of either the sheet or the mat, or may be incorporated directly into the sheet or the mat so that an additional coating layer is not required. As with the other attachment methods, there should be a sufficient amount of ferromagnetic material to ensure adequate attachment strength between the sheet 24 and the base mat 22, while allowing relatively easy removal of the sheet 24, as desired.

Still another method of securing a replaceable sheet to a base mat is by use of intermeshing structured surfaces that engage with each other to attach two surfaces together. One specific example of an intermeshing attachment system of this type is disclosed in U.S. Pat. No. 4,875,259 (Appledorn), which is commonly owned by the assignee of the present invention. These intermeshing structured surfaces have tapered elements, wherein each of the elements has at least one side inclined relative to a common plane at an angle sufficient to form a taper. In the present invention, both the base mat 22 and the replaceable sheet 24 may comprise a structured surface such that when the structured surface of the base mat 22 contacts the structured surface of the sheet 24, the tapered elements of each of these surfaces frictionally engage with each other. Another example of an intermeshing attachment system includes protrusions extending from either the base mat or the replaceable sheet that interlock with holes or recesses in the other of the base mat or replaceable sheet.

Any of the described attachment materials may be provided across the entire surface of both the replaceable sheet and the mat surface on which it will be secured or placed. However, the attachment materials may be provided on only a portion of the replaceable sheet, the mat surface, or both, depending on the desired level of attachment desired.

Although the above description generally discusses a single replaceable sheet on each mat base, it is understood that a matting assembly may include several replaceable sheets to display various graphics on a single mat. Each replaceable sheet have the same or different sizes, shapes, and colors as the other replaceable sheets on a particular mat.

When a person walks on a matting assembly 20 of the type shown in FIGS. 2a and 2b, the bottom of his or her shoes may come in contact with the sheet 24. Thus, a top surface 28 of sheet 24 may optionally be provided with anti-skid properties to minimize the chances of slippage between a shoe sole and the sheet 24. The top surface 28 may be scuffed or otherwise roughened to provide an anti-skid surface. Alternatively, a separate sheet or layer 50 may be coated or laminated onto the top sheet surface 28 of sheet 24, as shown in FIG. 5. One example of an appropriate material for use as layer 50 includes an anti-skid sheet commercially available from Minnesota Mining and Manufacturing Company (“3M”), St. Paul, Minn., under the trade designation “Fine Resilient SafetyWalk,” which generally includes abrasive pyramidal protrusions 52 that enhance the anti-skid properties of the sheet. Another example of a material appropriate for use as layer 50 is an anti-skid sheet available from the Minnesota Mining and Manufacturing Company under the trade designation “General Purpose Safety-Walk”, which includes abrasive grit that enhances the anti-skid properties of the sheet. Many other types of materials may be used to provide an anti-skid surface, such as microstructured surfaces. Furthermore, the anti-skid sheet may have graphic images or indicia printed on its abrasive surface topographically or on the surface of layer 50 opposite the pyramidal protrusions 52 by sublimation printing technology or by other printing methods.

A matting assembly 20 may further include indicia such as instructions, on the bottom wall 30 of recessed area 25. The indicia may explain to the user the recommended methods of attaching and removing replaceable sheets, for example. This indicia would be covered by a replaceable sheet when such sheet is positioned in the recessed area 25, but would be visible when the sheet is removed. A clear layer, such as a vinyl layer, may be coated over the indicia to protect the indicia while not significantly obscuring a view of the indicia.

It is further within the scope of the invention that replaceable sheet 24 be affixed to the top surface of a mat that does not include a recessed area. In this embodiment, the sheet 24 would extend above the surface of the mat.

It is understood that the present invention is also applicable to other matting configurations than those comprising the extruded parallel and undulating elements described above. Other examples of mats that may be used include resilient, vinyl loop matting (such as matting commercially available from the Minnesota Mining and Manufacturing Company of St. Paul, Minn., under the trade designation “Nomad”), carpet-type matting made of thermoplastic fibers such as nylon or polyester (such as matting commercially available from the Minnesota Mining and Manufacturing Company of St. Paul, Minn., under the trade designation “Enhance”), or rubber mat bases made of materials such as nitrile rubber mat bases commercially available from the Minnesota Mining and Manufacturing Company, St. Paul, Minn., under the trade designation “Oil Trap Mat.” One typically available configuration of an Oil Trap Mat is 3 foot (0.91 m) wide by 5 foot (1.52 m) long, which has a recessed area that is 0.125 inch (0.32 cm) deep and a 0.75 inch (1.9 cm) wide border around the perimeter of the recessed area. While these mats are typically flexible, the present invention also includes within its scope non-flexible matting materials such as matting assemblies having a flexible matting surface affixed to a non-flexible surface, such as a metal or wood base plate. In these embodiments, the matting and base plate assembly can be moved from location to location as a single unit. Also included within the scope of this invention are matting materials that are rigid without the use of an additional base plate.

The matting of the present invention described above may be used in any application where a person wishes to display a graphical image or message while providing a matting surface for a purpose such as removing dirt and moisture from shoe soles. The matting may also provide a non-slip walking surface for people stepping on the matting. In any case, the person (typically a business owner) can utilize matting materials both for their originally intended purpose and also to communicate some information to the person walking on the matting.

Typically, a user would order matting material in the size and shape desired for a particular area in which a mat will be placed. With the present invention, the mat would also typically be ordered with a recessed area of a certain size for receiving a replaceable sheet, although the recessed area may be omitted from some matting products, as described above. Referring back to FIG. 2a for an example of a mat having a recessed area, matting assembly 20 includes a replaceable sheet 24 and base mat 22 having a first surface 26, a second surface 27, and a recessed area 25. In the typical application, the user would receive the base mat 22 as a separate item from at least one replaceable sheet 24. If mat 22 was received in a roll, it would need to be unrolled and preferably placed on a flat surface. Depending on where the mat 22 was stored, it may need to be cleaned prepare it for receiving a sheet 24.

Next, the user would prepare the replaceable sheet 24 to be placed on the base mat 22. In some cases, sheet 24 may include a liner on its back surface to keep that surface free from contamination during shipping and storage. If sheet 24 includes such a liner, the liner would be removed and the sheet 24 would be positioned in the recessed area 25 so that the graphic image or indicia 34 is facing the desired direction relative to the base mat 22. The sheet 24 is then pressed down across its surface to affix it to the bottom wall 30 of recessed area 25. Matting assembly 20 may then be placed in the desired area for a period of time or moved from location to location as a single unit. During this time, customers would be able to walk on the matting assembly 20 and observe the particular graphic image or indicia 34 on the sheet 24.

After a period of time, the user may wish to change the replaceable sheet 24 to display a different graphic image or indicia 34. This may happen, for example, when the user changes its promotions or sales and wants to inform its customers of the new promotion. In this case, the first sheet 24 can be removed and replaced with a second sheet in the manner described above for placing a first sheet on the base mat 22. This sequence of removing and replacing sheet can be repeated multiple times throughout the life of the base mat 22. In this way, the floor surface of the business can be used both for removing dirt and moisture from the soles of shoes, while communicating changeable information to people walking on the matting.

It is further contemplated that a stack of sheets 24 be positioned within the recessed area 25 so that the user can simply peel back the top sheet to expose the sheet immediately below it. This arrangement would typically be advantageous for a user who knows its promotions in advance and wishes to save the time associated with the removal and replacement of sheets for each promotion.

The present invention may also be applicable to trays, such as passenger trays used in airplanes or serving trays in restaurants. In this application, a rigid tray base comprises a face surface that can accept replaceable sheets generally of the type described above. The replaceable sheet can display indicia or graphics, and may also comprise a non-slip surface to help prevent slippage of glasses, plates, and the like with movement of the plane when those items are placed on the tray. As with the floor matting, each replaceable sheet may be periodically removed and replaced with a new sheet when desired.

Finally, the present invention may also be applicable to table mats and matting materials that can be applied to walls or other horizontal or vertical surfaces. Again, replaceable sheets can be removably attached to a base surface and be periodically removed and replaced with new sheets, as desired.

The present invention has now been described with reference to several embodiments thereof. The entire disclosure of any patent or patent application identified herein is hereby incorporated by reference. The foregoing detailed description and examples have been given for clarity of understanding only. No unnecessary limitations are to be understood therefrom. It will be apparent to those skilled in the art that many changes can be made in the embodiments described without departing from the scope of the invention. Thus, the scope of the present invention should not be limited to the structures described herein, but only by the structures described by the language of the claims and the equivalents of those structures.

1. A method of communicating information, comprising the steps of:
a) providing a base mat adapted for receiving at least one replaceable sheet, the base mat having first and second opposing surfaces;
b) providing a first replaceable sheet having a base surface and an opposing face surface, wherein the face surface displays indicia;
c) removably attaching the first replaceable sheet to at least a portion of the first surface of the base mat so that the base surface of the sheet faces the first surface of the base mat;
d) displaying the base mat having the first removably attached replaceable sheet for a period of time;
e) removing the first replaceable sheet when desired;
f) providing a second replaceable sheet having a base surface and an opposing face surface, wherein the face surface displays indicia;
g) removably attaching the second replaceable sheet to at least a portion of the first surface of the base mat so that the base surface of the sheet faces the first surface of the base mat.

2. The method of claim 1 wherein the face surface of the first replaceable sheet comprises a non-slip material.

3. The method of claim 1, wherein at least a portion of the base surface of the first replaceable sheet comprises an adhesive coating.

4. The method of claim 1, wherein at least a portion of the first surface of the matting article comprises a vinyl layer.

5. The method of claim 1, wherein the base mat comprises a flexible matting material.

6. The method of claim 1, wherein the step of providing a base mat further comprises providing a base mat including at least one recessed area.

7. The method of claim 6, wherein the step of removably attaching the first replaceable sheet comprises attaching the first replaceable sheet within the recessed area of the base mat.

8. The method of claim 1, wherein the base surface of the first and second replaceable sheets comprises a first fastening means.

9. The method of claim 8, wherein the first fastening means is an adhesive.

10. The method of claim 9, wherein the adhesive is a non-tacky adhesive.

11. The method of claim 9, wherein the adhesive is a repositionable adhesive.

12. The method of claim 8, wherein the first opposing surface of the base mat comprises a second fastening means.

13. The method of claim 12, wherein the first fastening means is a hook material and the second fastening means is a loop material.

14. The method of claim 12, wherein the first fastening means is a loop material and the second fastening means is a hook material.

15. The method of claim 1, further comprising the step of adapting the base mat to receive the first replaceable sheet.

16. The method of claim 15, wherein the step of adapting the base mat comprises providing a vinyl sheet on at least a portion of the first surface of the base mat.

17. The method of claim 12, wherein the first fastening means comprises a ferromagnetic material and the second fastening means comprises a magnetized surface.

18. The method of claim 12, wherein the first fastening means comprises a magnetized surface and the second fastening means comprises a ferromagnetic material.

19. A method of communicating information, comprising the steps of:
a) providing an article adapted for receiving at least one replaceable sheet, the article having first and second opposing surfaces;
b) providing a first replaceable sheet having a base surface and an opposing face surface, wherein the face surface displays indicia;
c) removably attaching the first replaceable sheet to at least a portion of the first surface of the article so that the base surface of the sheet faces the first surface of the article;
d) displaying the article having the first removably attached replaceable sheet for a period of time;
e) removing the first replaceable sheet when desired;
f) providing a second replaceable sheet having a base surface and an opposing face surface, wherein the face surface displays indicia;
g) removably attaching the second replaceable sheet to at least a portion of the first surface of the article so that the base surface of the sheet faces the first surface of the article.
